(19) United States
(12) Patent Application Publication
(10) Pub. No.: US 2014/0022987 A1
(43) Pub. Date: Jan. 23, 2014

(54) WIRELESS MOBILE DEVICE, SYSTEM AND METHOD OF BROADCASTING WIRELESS STREAMING MEDIA

(71) Applicant: AVERMEDIA TECHNOLOGIES, INC., New Taipei City (TW)

(72) Inventors: Jui-Hung KAO, TAIPEI HSIEN (TW); Jiun-Kuei JUNG, NEW TAIPEI CITY (TW)

(73) Assignee: AVERMEDIA TECHNOLOGIES, INC., NEW TAIPEI CITY (TW)

(21) Appl. No.: 13/645,477

(22) Filed: Oct. 4, 2012

(30) Foreign Application Priority Data
Jul. 18, 2012 (TW) 101125835

(51) Int. Cl. H04W 4/00

(52) U.S. Cl. 370/328

(57) ABSTRACT

A wireless mobile device, a system and a method of broadcasting wireless streaming media are disclosed, where the device includes an eavesdropping module, a packet-filtering module and a streaming player unit. The eavesdropping module can eavesdrop packets of streaming data through a wireless network. The packet-filtering module can determine whether the packets of the streaming data have identification information. When the packets of the streaming data have the identification information as determined, the packet-filtering module can allow the streaming data to be passed. The streaming player unit can play media based on the passed streaming data.

### RELATED APPLICATIONS

This application claims priority to Taiwan Application Serial Number 101125835, filed Jul. 18, 2012, which is herein incorporated by reference.

### BACKGROUND

1. Field of Invention

The invention relates the wireless network communication technology. More particularly, the invention relates to a wireless mobile device, a system and method of broadcasting wireless streaming media.

2. Description of Related Art

The popularity of wireless transmission improves the convenience of using network for human beings. However, because of the bandwidth limitation of the wireless transmission, the number of users served by one wireless base station has the inherent bandwidth limitation after all.

As shown in FIG. 1, a unicast streaming server 100 is connected to one wireless base station 110, while N streaming requestors each use the wireless network interfaces on the mobile devices 121, 122 . . . 12N to transmit a request to the streaming server 100 through the wireless base station so as to obtain the streaming service. After the unicast streaming server 100 receives the request from the streaming requestors, the unicast streaming packets are transmitted to the streaming requestors through the wireless base station 110 in a wireless transmission manner. Since each streaming requestor requests the streaming service from the unicast streaming server in the same way, every time one streaming requestor is added, both the demand for the unicast streaming bandwidth (download bandwidth) and the demand for the requesting bandwidth (upload bandwidth) are doubled. As shown in FIG. 1, the mobile devices 121, 122 . . . 12N are used by N streaming users. Accordingly, N of the total bandwidth (upload bandwidth plus download bandwidth) of the wireless base station are occupied. Once the total bandwidth demand reaches the upper bandwidth limit of the wireless network, the wireless base station 110 cannot provide more streaming services. This results in the limitation to the number of users for the method where the unicast streaming server 100 transmits the digital streaming through the wireless base station 110. The higher the bandwidth demand of the digital streaming, the less total number of users is allowed.

In order to save the bandwidth of the unicast streaming method, referring to FIG. 2, it is a method where a multicast streaming server 200 is used to transmit the multicast streaming to the streaming requestors through a wireless base station 210. The multicast streaming server 200 is connected to one wireless base station 210, while N streaming requestors each use the wireless network interfaces on the mobile devices 221, 222 . . . 22N to transmit a request to the streaming server 200 through the wireless base station 210 so as to join the multicast group and obtain the streaming service. After the streaming server 200 receives the request from the streaming requestors, the streaming server 200 only transmits one streaming packet to the streaming requestors through the wireless base station 210 in a wireless multicast manner. Only one streaming is transmitted through the wireless base station 210, but each streaming user receives the streaming. Accordingly, in fact only one streaming bandwidth (download bandwidth) is used. Each streaming requestor requests the streaming service from the streaming server 200 in the same way. Accordingly, every time one streaming requestor is added, the demand for the requesting bandwidth (upload bandwidth) is doubled while the demand for the streaming bandwidth (download bandwidth) is unchanged. As shown in FIG. 2, for N streaming users, one download bandwidth and N upload bandwidths of the wireless base station are occupied.

The method using the multicast streaming server makes use of the wireless multicast to solve the download bandwidth demand problem. However, the method, which uses the wireless multicast to transmit the streaming, causes at least the following three problems. Firstly, the wireless multicast method only transmits the packet for once, but all the streaming users receive the packet, so that when the wireless multicast packet has an error, the streaming requestors cannot request the wireless base station 210 to retransmit the packet. The wireless transmission medium is an unreliable transmission medium with a high interference. Accordingly, transmitting the packet wirelessly has a high error rate. In the environment of high packet error rate, the audiovisual streaming playing quality of the streaming requestors is poor and even the audiovisual playing cannot be performed. Secondly, the multicast streaming server 200 only solves the download bandwidth problem, while the upload bandwidth problem still exists. In this mechanism, the streaming users still occupy N upload bandwidths, which causes that the total upload bandwidth is increased along with the number of users. In the condition of the limited total bandwidth, the number of users has an upper limit. Thirdly, when the multicast is performed on a general wireless network, in order to make all the mobile devices 221, 222 . . . 22N receive the multicast data, the wireless base station 210 usually switches to a more inefficient transmission mode automatically. For example, a wireless base station of 802.11a/b/g may switch to the mode of 802.11b with a low bandwidth (11 Mbps) automatically, instead of a better transmission mode, such as 802.11g (54 Mbps) used in the unicast condition. This can result in the inefficient usage of the wireless network and a better transmission bandwidth cannot be used. Additionally, a general commercially available wireless network base station is inefficient to process the multicast packet, which may generally cause the significant performance degradation of the entire wireless network.

Taking 802.11 as an example, for the existing 802.11 system, it can be seen that the second problem becomes more obvious. The media access control (MAC) protocol of 802.11 is designed to use the carrier sense multiple access with collision avoidance (CSMA/CA) method. Since in the wireless transmission media it is difficult to correctly detect whether a frame collision occurs, the method avoiding the collision actively is used instead of the method detecting passively, so as to solve the frame collision problem. A distributed coordination function (DCF) is used in the CSMA/CA protocol to avoid the collision. This distributed function uses a competitive design and two methods are mainly used in this function to avoid the frame collision. In one method, when having a frame to transmit, the mobile device waits and monitors whether the transmission channel is idle. When the transmission channel remains idle for a period, the device waits for another random period. If the transmission channel is still idle, the device transmits the frame. If the frame collision occurs, the device waits again. Since the waiting time of each device is each generated at random, the possibility of collision taking place when respective devices transmit a frame simultaneously can be reduced. The other method is an RTS-CTS handshake protocol. Before transmitting a long frame, the device transmits a very small RTS (Request to Send) frame to the target end and the frame includes a transmission time (NAV, Net Allocation Vector) required thereafter. After receiving the RTS, the target end returns a CTS (Clear to Send) frame to the source end. After receiving the RTS, the non-target device also reads the NAV in the RTS and adds the NAV into its waiting time. After the source terminal receives the CTS, transmitting is started. This method can ensure that when the source device is transmitting data thereafter no other device transmits the frame at the same time to cause the frame collision. Since both the RTS frame and the CTS frame are very small and are only used before a long frame is transmitted, the transmission cost is reduced. However, such a system design causes the transmission cost to be double increased along with the increase of the number of users. When the number of users is increased, the competition becomes more intense, so that even if the device has waited for an idle period, due to too large number of users the possibility of the frame collision is too high and the status of simultaneous frame transmission often occurs. The excessive competition status causes that no one can transmit the frame successfully at last, and thus the entire wireless network falls into a paralyzed condition. This also makes the design of 802.11 amplify the above-mentioned second problem, so that 802.11 is not suitable to be used in the broadcasting streaming condition as the design of 802.11 amplifies the increased number of users resulting in the bandwidth utilization declination.

In order to solve the problem of performing the Wi-Fi video multicasting on the Wi-Fi wireless network, some people has issued academic papers in IEEE journals (“Eavesdropping wireless video packets to improve standard multicast transmission in Wi-Fi networks” and “WEVCast: Practical implementation and testing of effective multicast services for Wi-Fi networks”). The method includes setting the same MAC address and IP alias for all devices to receive the streaming under the wireless network. In such a way, all streaming receivers believe that the streaming data transmitted from the streaming server are directed to themselves. Accordingly, they receive and play the streaming data. However, this method has at least two defects: firstly, since plural devices in the wireless network use the same MAC address, the network connections of these devices collide with each other, and thus substantially, these devices can only receive the multicast streaming in such an application, and they cannot be connected to other networks at the same time; and secondly, when the MAC address is switched, it is needed to reset the wireless network drive program, and it is even needed to reset the entire wireless network device. Accordingly, it is inconvenient to use these devices. When the WEVCast system provides plural streamings simultaneously, the streaming receive end needs to switch to different MAC addresses so as to realize the purpose of switching the streaming, which declines the utilization greatly.

It can be seen that, the above-mentioned existing wireless streaming transmission methods are still inconvenient and have defects, needing to be further improved. In order to solve the above-mentioned problems, people in the related fields are trying to find the solution painstakingly. However, for such a long time, no applicable methods have been developed or completed. Accordingly, how to use the network bandwidth efficiently and meanwhile adopt the optimal transmission parameters is one of the current important research subjects and is also a target to be improved urgently in the current related fields.

### SUMMARY

Accordingly, an aspect of the invention provides a wireless mobile device, a system and method of broadcasting wireless streaming media so as to solve or avoid the problems of the prior art.

According to an embodiment of invention, a wireless mobile device includes an eavesdropping module, a packet-filtering module and a streaming player unit. The eavesdropping module is used for eavesdropping a packet of streaming data through a wireless network. The packet-filtering module is used for determining whether the packets of the streaming data have identification information. When the packets of the streaming data have the identification information as determined, the packet-filtering module allows the streaming data to be passed. The streaming player unit is used for playing media based on the passed streaming data.

The above-mentioned wireless mobile device includes a forward error-correction code (FEC) removing module. The FEC removing module is used for removing a forward error-correction code from the passed streaming data. After the forward error-correction code is removed, the streaming player unit plays media based on the passed streaming data.

The above-mentioned wireless mobile device may further include a preload module. The preload module is used for preloading the identification information as recognition information. The packet-filtering module determines whether headers of the packets of the streaming data have the identification information. When the headers have no identification information, the packet-filtering module filters the packets of the streaming data. When the headers have the identification information, the packet-filtering module allows the streaming data to be passed.

The above-mentioned wireless mobile device may further include a preload module and a switch unit. The preload module is used for preloading the identification information in the headers of a plurality of different packets of the streaming data. The switch unit is used for selecting one from the identification information as recognition information. The eavesdropping module eavesdrops the different packets of the streaming data. The packet-filtering module only allows the packets of the streaming data with the recognition information in the different packets of the streaming data to be passed.

The above-mentioned streaming data is video streaming data, audiovisual streaming data, or audio streaming data.

According to another embodiment of the invention, a system of broadcasting wireless streaming media includes a wireless transmission device and a streaming server. The streaming server includes a receiving module, a processing module and a transmission module. When one of the plural wireless mobile devices transmits a streaming service request through a wireless network, the receiving module is used for receiving the streaming service request through the wireless transmission device. The processing module is used for generating the packets of the streaming data and adding identification information to the packets of the streaming data. The transmission module is used for transmitting the packets of the streaming data to the wireless mobile device transmitting the streaming service request through the wireless transmission device in an unicast manner, while the other wireless mobile devices are eavesdropping the packets of the streaming data.

The above-mentioned wireless transmission device is a wireless base station. The wireless base station is connected to the streaming server through a wired network.

Alternatively, the above-mentioned wireless transmission device is installed in the streaming server.

The above-mentioned processing module encodes the streaming data with the forward error-correction code and then provides the packets of the streaming data. These wireless mobile devices decode and recover the forward error-correction code and then play media based on the streaming data.

The number of the above-mentioned streaming servers is plural. When each receiving the streaming service request, these streaming servers transmit the different packets of the streaming data to the corresponding wireless mobile device transmitting the streaming service request in the unicast manner, while the other wireless mobile devices eavesdrop these different packets of the streaming data. When the identification information of any one of these different packets of the streaming data matches with recognition information set by the eavesdropping wireless mobile devices, the eavesdropping wireless mobile devices receive the packets of the streaming data matching with the recognition information and play media based on the streaming data.

The above-mentioned wireless network is a Wi-Fi wireless network or a wireless network of 802.11.

According to still another embodiment of the invention, a method of broadcasting wireless streaming media includes the following steps: (a) receiving a streaming service request when one of the plural wireless mobile devices transmits the streaming service request through a wireless network; (b) generating packets of streaming data and adding identification information to the packets of the streaming data; and (c) transmitting the packets of the streaming data to the wireless mobile device transmitting the streaming service request in the unicast manner, while the other wireless mobile devices eavesdrop the packets of the streaming data.

The step (b) includes: encoding the streaming data with a forward error-correction code and then providing the packets of the streaming data so that these wireless mobile devices decode and recover the forward error-correction code and then play media based on the streaming data.

In the method of broadcasting wireless streaming media, when the identification information matches with the recognition information set by the eavesdropping wireless mobile devices, the eavesdropping wireless mobile devices receive the packets of the streaming data matching with the recognition information and play media based on the streaming data.

In sum, comparing with the prior art, the technical solution of the invention has obvious advantages and beneficial effects. Through the above-mentioned technical solution, significant technical improvement can be reached with extensive utilization value in the industry. The technical solution has at least the following advantages:

1. When the invention is used, increasing of the number of the streaming audiences (i.e., the eavesdropping wireless mobile devices) does not increase the wireless network bandwidth required by the wireless digital streaming. Comparing with the conventional method, the number of users served by the to system architecture of the invention is increased greatly;

2. Since the unicast method is used to perform the streaming between the streaming server and the streaming requestor (i.e., the wireless mobile device transmitting the streaming service request), the streaming can use the optimal transmission parameters in the wireless network environment and it is not limited by the low bit-rate transmission parameters that are necessary in the conventional multicast status;

3. Except the streaming requestor, the other streaming audiences receive the streaming packets passively and do not transmit the IGMP packet or other Wi-Fi requests, which reduces the possibility of packet collision on the Wi-Fi network greatly, and thus comparing with the conventional multicast, this system can make use of the Wi-Fi bandwidth more efficiently; and

4. The invention does not make any modification to the wireless network standard protocol (e.g., 802.11) and uses the inherent eavesdropping character and function of all devices on the wireless network, so that it can be implemented simply on the commercially available wireless network devices, without modifying the hardware or drive program of the wireless network.

The detailed description for the above illustration will be made through the embodiments below and a further explanation for the technical solution of the invention will be provided.

### BRIEF DESCRIPTION OF THE DRAWINGS

In order to make the foregoing as well as other aspects, features, advantages, and embodiments of the invention more apparent, the accompanying drawings are described as follows:

FIG. 1 illustrates a transmission manner of an unicast streaming system using a wireless base station;

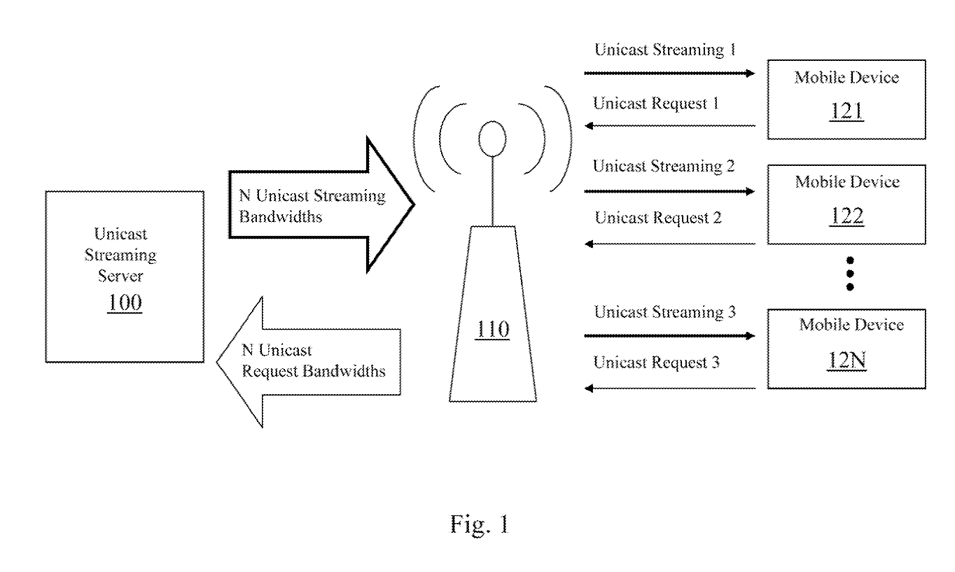

FIG. 2 illustrates a transmission manner of a multicast streaming system using a wireless accessor;

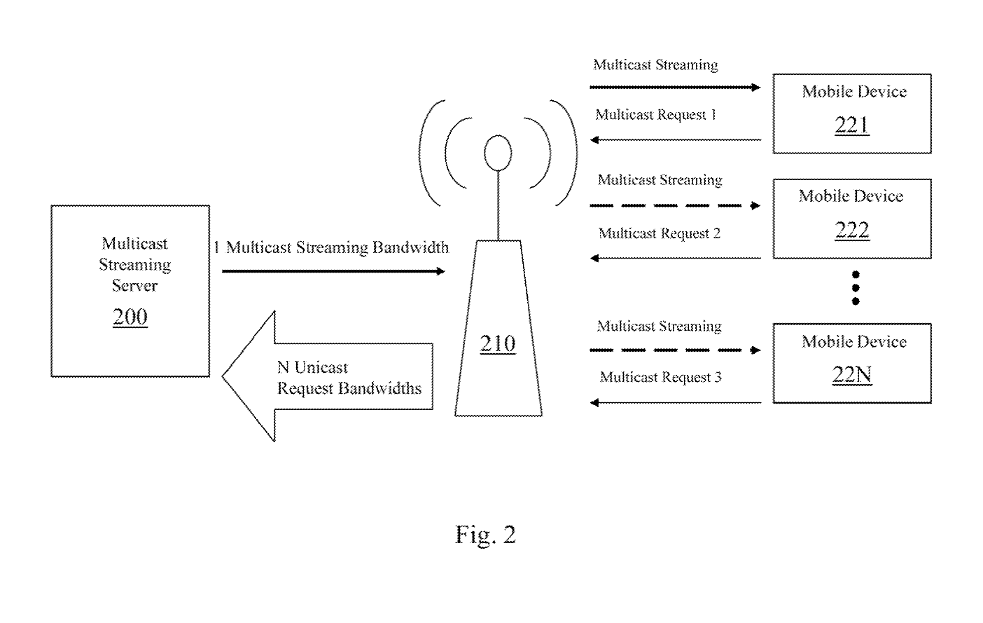

FIG. 3 illustrates a schematic view of a system of broadcasting wireless streaming media according to an embodiment of the invention;

FIG. 4 illustrates a schematic view of a system of broadcasting wireless streaming media according to another embodiment of the invention;

FIG. 5 illustrates a block diagram of a wireless mobile device according to an embodiment of the invention;

FIG. 6 illustrates a block diagram of a system of broadcasting wireless streaming media according to an embodiment of the invention;

FIG. 7 illustrates a block diagram of a system of broadcasting wireless streaming media according to another embodiment of the invention; and

FIG. 8 illustrates a flow chart of a method of broadcasting wireless streaming media according to an embodiment of the invention.

### DETAILED DESCRIPTION

In order to make the description of the invention more detailed and more comprehensive, various embodiments of the invention are described below with reference to the accompanying drawings. Wherever possible, the same reference numbers are used in the drawings and the description to refer to the same or like parts. On the other hand, well-known components and steps are not described in embodiments so as to avoid the unnecessary limitation to the invention.

In embodiments and claims, the articles “a”, “an” and “the” refer to one or more, unless expressly specified otherwise.

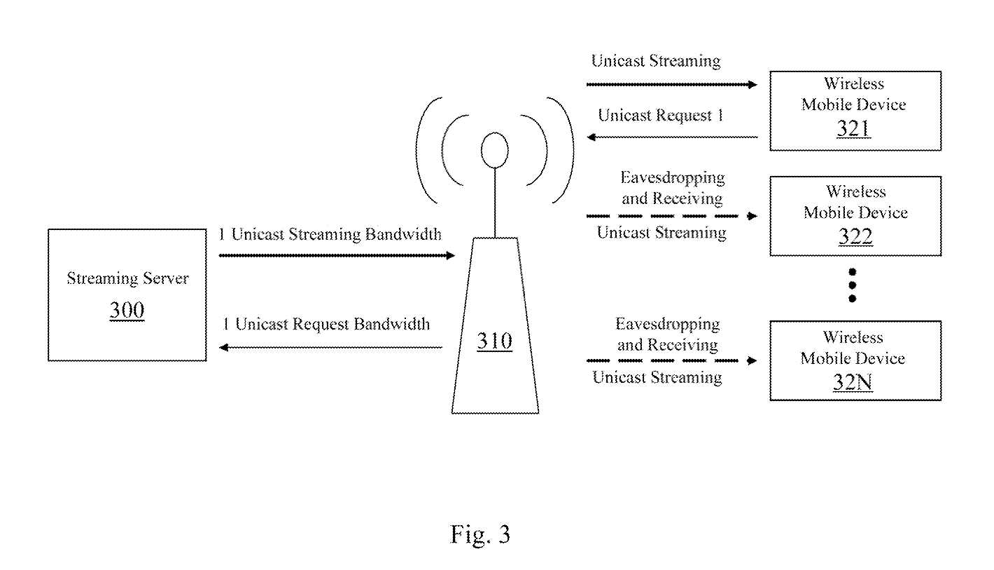

Referring to FIG. 3, it illustrates a schematic view of a system of broadcasting wireless streaming media according to an embodiment of the invention. As shown in FIG. 3, the system of broadcasting wireless streaming media includes a streaming server 300 and a wireless transmission device 310. In this embodiment, the wireless transmission device 310 may be a wireless base station. The wireless base station is connected to the streaming server 300 through a wired network, so as to avoid occupying bandwidth of the wireless network and avoid the possibility of packet collision in the wireless network. In this system, only one streaming requestor (e.g., a wireless mobile device 321) exists and the others are streaming audiences (e.g., wireless mobile devices 322 . . . 32N). The wireless mobile device 321 uses its wireless network interface to transmit a streaming service request to the streaming server 300 through the wireless transmission device 310, so as to perform the streaming service. After receiving the streaming service request, the streaming server 300 adds identification information to the packets of the streaming data. In this embodiment, the identification information is added to the headers of the packets. The identification information can be a special identification code (token/ID). Then, the packets of the streaming data are transmitted to the wireless mobile device 321 through the wireless transmission device 310 in a wireless unicast manner.

Furthermore, the above-mentioned unicast streaming packets can be encoded with the forward error-correction code (FEC). In this way, if the packet has an error, the corrupt packet can be recovered to a correct packet through recalculation without retransmitting the packet, so that the first problem (i.e., a packet having an error) in the prior art can be solved.

When the streaming audiences (i.e., wireless mobile devices 322 . . . 32N) plan to receive the streaming, at first users make use of the wireless mobile device to obtain the identification information through network download, manual entry or barcode scanning and other manners. Then the streaming audiences eavesdrop and receive the streaming packets that are being transmitted from the wireless base station 310 to the streaming requestor, filter the packets which have identification information in headers, remove the forward error-correction code and then transmit the streaming data to the player software to play. In addition to filtering the packets through a special identification code (token/ID), the streaming audiences also can filter the streaming packets through the network addresses of the streaming server 300 and the streaming requestor (i.e., wireless mobile device 321) or a part of the field information in other headers (e.g., MAC address, IP address/port, protocol, etc.). The prerequisite is that the streaming audiences obtain the identification information for how to filter the packets in advance.

In other words, the streaming audiences (i.e., wireless mobile devices 322 . . . 32N) eavesdrop and receive the streaming data from the wireless transmission device 310, but the streaming audiences do not request data from the streaming server 300 directly. In fact, only one device (i.e., wireless mobile device 321) requests streaming from the streaming server 300 and only one streaming is transmitted by the wireless transmission device 310. Accordingly, no matter how many streaming audiences are increased, neither additional streaming bandwidth (download bandwidth) nor additional request bandwidth (upload bandwidth) is increased. This makes the wireless transmission device 310 serving as a wireless base station transmit the streaming to a large number of streaming audiences by way of broadcasting, without increasing the used wireless bandwidth. Transmitting streaming by such a broadcasting way can overcome the second problem (insufficient bandwidth caused by the increasing number of users) in the prior art efficiently.

The eavesdropping of the wireless network is illustrated below for supplement. The media of the wireless network are open spaces, and thus the devices on the same wireless network usually can receive all packets transmitted between the base station and other devices. In other words, the eavesdropping is an inherent character of the wireless network, but in a general condition, each wireless network device filters the eavesdropped packet and only keeps the packet transmitted from the base station or other devices to the device itself. On a general personal computer (PC) or a mobile device, the eavesdropping function can be realized through software, e.g., the wireshark (libpcap) program on Windows platform or tcpdump on Linux platform and the like.

The system shown in FIG. 3 for example can be applied to a big concert. The audiences far away from the stage can make use of the wireless mobile devices (e.g., mobile phones, tablet computers, notebook computers, etc.) to receive the audiovisual streaming data so that they can see the wonderful real condition on the stage in real time.

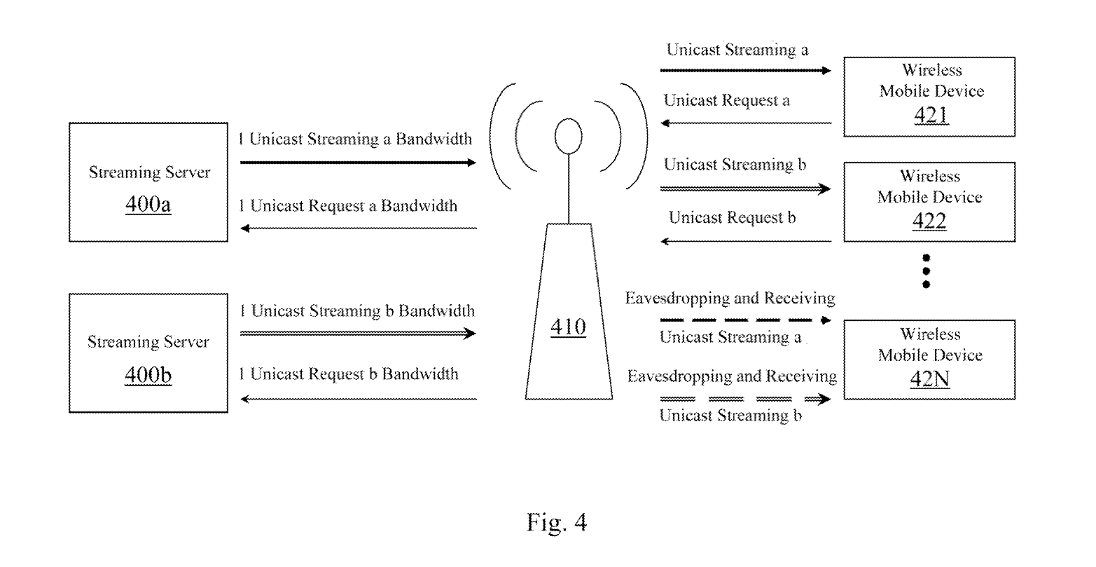

Additionally, referring to FIG. 4, it illustrates a schematic view of a system of broadcasting wireless streaming media according to another embodiment of the invention. As shown in FIG. 4, the system of broadcasting wireless streaming media includes plural streaming servers 400a, 400b and a wireless transmission device 410. In the architecture, the wireless transmission device 410 can serve as a wireless base station. The wireless base station can make more than one streaming servers 400a and 400b broadcast the streaming simultaneously. The streaming servers 400a, 400b mark their identification information in the headers of packets of the streaming data. Different packets of the streaming data have respective different identification information. In an embodiment, as a streaming requestor, the wireless mobile device 421 transmits a streaming service request a to the streaming server 400a through the wireless transmission device 410. After the streaming server 400a receives the streaming service request a, the streaming server 400a transmits the packets of the streaming data a to the wireless mobile device 421 through the wireless transmission device 410 in a wireless unicast manner. Similarly, as another streaming requestor, the wireless mobile device 422 transmits a streaming service request b to the streaming server 400b through the wireless transmission device 410. After the streaming server 400b receives the streaming service request b, the streaming server 400b transmits the packets of the streaming data b to the wireless mobile device 422 through the wireless transmission device 410 in the wireless unicast manner. As a streaming audience, the wireless mobile device 42N can eavesdrop plural streaming data a, b at the same time. The streaming audiences can select the streaming data to play by screening different identification information. Since two packets of the streaming data are eavesdropped simultaneously by the streaming audience, users do not need to re-grab and buffer the streaming packets when they switch different identification information. Accordingly, the period during which different streaming audiovisual images are switched is very short.

The system shown in FIG. 4 for example can be applied to a baseball field. When watching the game, the audience can make use of the wireless mobile devices (e.g., mobile phones, tablet computers, notebook computers, etc.) to select their desired image streaming data, e.g., left field real-time image, right field real-time image, etc.

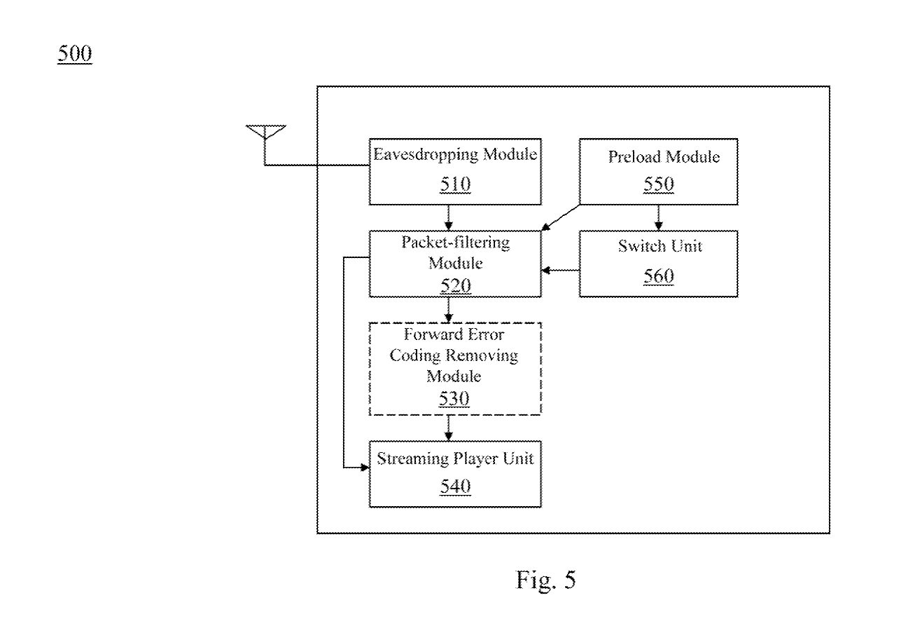

In order to further describe the operation mechanism of the above-mentioned wireless mobile devices serving as the streaming audiences, referring to FIG. 5, it illustrates a block diagram of a wireless mobile device 500 according to an embodiment of the invention. The architecture of the wireless mobile device 500 can be applied to any wireless mobile device shown in FIGS. 3 and 4.

As shown in FIG. 5, the wireless mobile device 500 includes an eavesdropping module 510, a packet-filtering module 520 and a streaming player unit 540. The eavesdropping module 510 is used for eavesdropping a packet of streaming data through a wireless network. The packet-filtering module 520 is used for determining whether the packets of the streaming data have identification information. When the packets of the streaming data have the identification information as determined, the packet-filtering module 520 allows the streaming data to be passed. The streaming player unit 540 is used for playing media based on the passed streaming data. For example, the streaming data is video streaming data, audiovisual streaming data or audio streaming data. The streaming player unit 540 can be a streaming playing software. The streaming playing software can be used to play image, video and audio, sound and other information.

Furthermore, the wireless mobile device 500 may further include a forward error-correction code (FEC) removing module 530. If the packets of the streaming data are encoded with the forward error-correction code, the FEC removing module 530 is used for removing the forward error-correction code from the streaming data that have passed the packet-filtering module 520. After the forward error-correction code is removed, the streaming player unit 540 plays media based on the streaming data.

In an embodiment, a streaming server adds identification information to the packets of the streaming data. The identification information can be a special identification code (token/ID), a network address of the streaming server, a network address of the streaming requestor, a part of the field information in the headers or other available information. The wireless mobile device 500 may include a preload module 550. The preload module 550 is used for preloading the identification information as recognition information. The packet-filtering module 520 determines whether the headers of packets of the streaming data include the identification information. When the headers do not include the identification information, it means that the eavesdropped packets are not transmitted from the streaming server. Accordingly, the packet-filtering module 520 filters the packets of the streaming data. On the contrary, when the headers include the identification information, it means that the eavesdropped packets are transmitted from the streaming server. Accordingly, the packet-filtering module 520 allows the streaming data to be passed and the streaming player unit 540 plays media based on the streaming data.

In another embodiment, plural streaming servers transmit different streaming data simultaneously. The wireless mobile device 500 may further include a switch unit 560 so that users can select the streaming data to play. The preload module 550 is used for preloading the identification information in the headers of plural different packets of the streaming data. The switch unit 560 is used for selecting one of the preloaded identification information as recognition information. The eavesdropping module 510 eavesdrops the different packets of the streaming data. The packet-filtering module 520 only allows the packets of the streaming data with the recognition information in these different packets of the streaming data to be passed. The streaming player unit 540 plays media based on the streaming data. In implementation, for example, the switch unit 560 can be an input interface (such as a touch screen) which is operated in combination with software. In this way, users can select the streaming data to receive as they like.

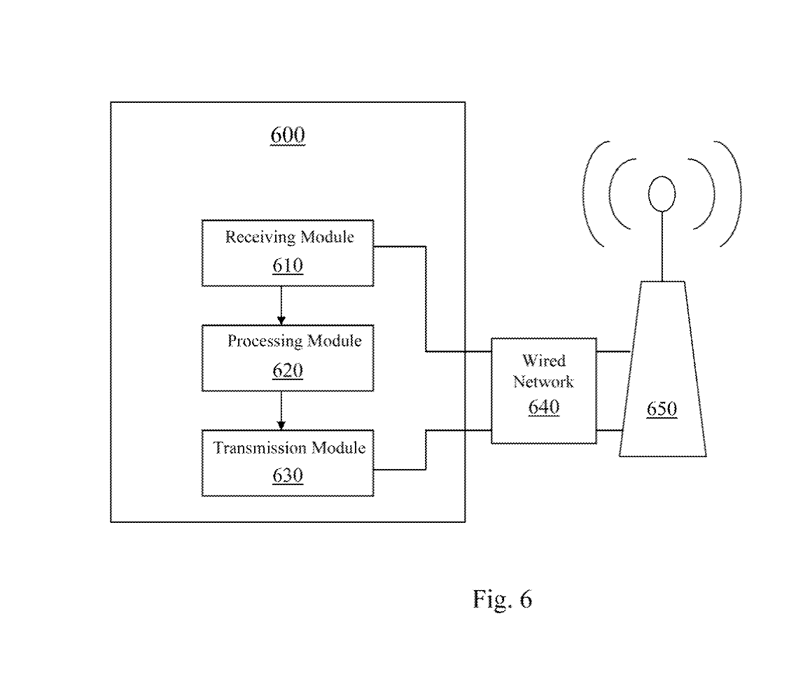

In order to further describe the mechanism of the system of broadcasting wireless streaming media, referring to FIG. 6, it illustrates a block diagram of a system of broadcasting wireless streaming media according to an embodiment of the invention. As shown in FIG. 6, the system of broadcasting wireless streaming media includes a streaming server 600 and a wireless transmission device 650. The architecture of the streaming server 600 can be applied to any streaming server shown in FIGS. 3 and 4.

In FIG. 6, the streaming server 600 includes a receiving module 610, a processing module 620 and a transmission module 630. When one of the above-mentioned plural wireless mobile devices (i.e., streaming requestor) transmits a streaming service request through a wireless network (e.g., Wi-Fi wireless network or wireless network of 802.11), the receiving module 610 is used for receiving the streaming service request through the wireless transmission device 650. The processing module 620 is used for generating packets of the streaming data and adding identification information to the packets of the streaming data. The transmission module 630 is used for transmitting the packets of the streaming data to the wireless mobile device (i.e., the streaming requestor) transmitting the streaming service request through the wireless transmission device 650 in the unicast manner, while the other wireless mobile devices (i.e., streaming audiences) eavesdrop the packets of the streaming data.

In order to solve the problem of packet error, the processing module 620 encodes the streaming data with a forward error-correction code and then providing the packets of the streaming data. The wireless mobile devices decode and recover the forward error-correction code and then play media based on the streaming data.

In implementation, in the system of broadcasting wireless streaming media, plural streaming servers 600 can be set (such as the architecture shown in FIG. 4). When each receiving a streaming service request, these streaming servers transmit different packets of the streaming data to the corresponding wireless mobile device (i.e., streaming requestor) transmitting the streaming service request in the unicast manner, while the other wireless mobile devices (i.e., streaming audiences) eavesdrop these different packets of the streaming data. When the identification information of any one of these different packets of the streaming data matches with recognition information set by the eavesdropping wireless mobile devices (i.e., streaming audiences), the eavesdropping wireless mobile devices (i.e., streaming audiences) only receive the packets of the streaming data matching with the recognition information and play media based on the streaming data.

In FIG. 6, the wireless transmission device 650 is a wireless base station. The wireless base station is connected to the streaming server 600 through the wired network 640, so as to avoid occupying the bandwidth of the wireless network and avoid the possibility of packet collision in the wireless network.

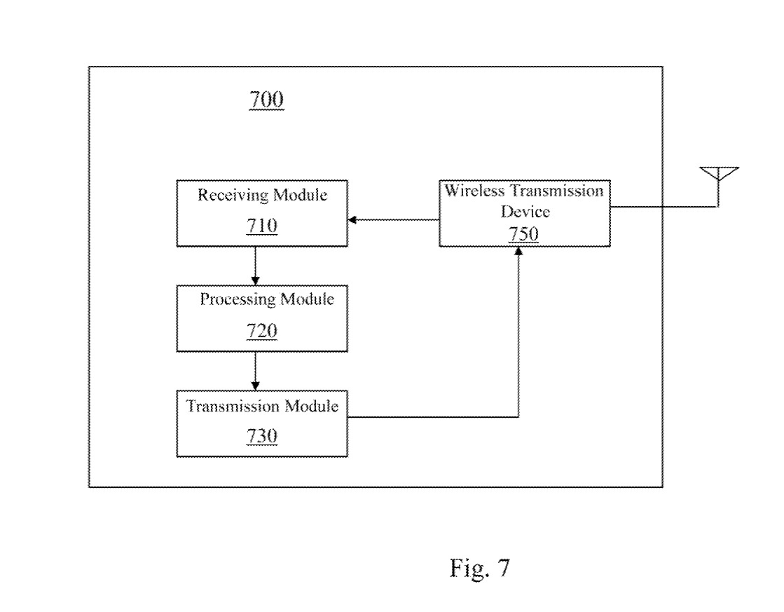

Alternatively, as shown in FIG. 7, a wireless transmission device 750 is installed in a streaming server 700. In this way, the streaming server 700 transmits packets of the streaming data to the streaming requestor wirelessly and directly in an ad hoc mode, without through the wireless base station. Other streaming audiences still can eavesdrop and receive the streaming data. The operation manner of a receiving module 710, a processing module 720 and a transmission module 730 in the streaming server 700 is the same as that of the receiving module 610, the processing module 620 and the transmission module 630 in FIG. 6, and thus it will not be illustrated any more.

The above-mentioned eavesdropping module 510, packet-filtering module 520, FEC removing module 530, streaming player unit 540, preload module 550, switch unit 560, receiving module 610, processing module 620, transmission module 630, etc., can be implemented as software, hardware and/or firmware. For example, if the execution speed and accuracy is a primary consideration, then each module and each unit can be mainly selected from hardware and/or software; if the design flexibility is a primary consideration, then each module and each unit can be mainly selected from software; and alternatively, each module and each unit can make use of software, hardware and firmware cooperatively. It should be known that, the above-mentioned examples are not classified as better or worse and they are not used to limit the invention. Those of skills in the art can flexibly select the specific implementation for each module and each unit, depending on the current demand.

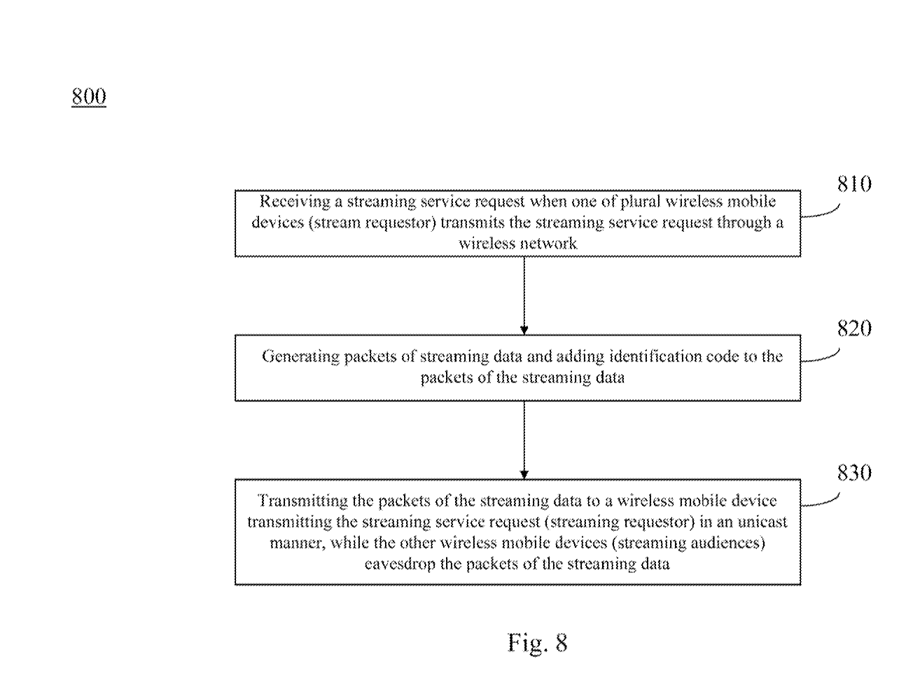

Another technical aspect of the invention is a method of broadcasting wireless streaming media, which can be applied to the above-mentioned system of broadcasting wireless streaming media or can be applied to the related technical sections extensively. With reference to FIG. 8, the specific embodiment of this method of broadcasting wireless streaming media is illustrated below.

FIG. 8 illustrates a flow chart of a method of broadcasting wireless streaming media 800 according to an embodiment of the invention. As shown in FIG. 8, the method 800 of broadcasting wireless streaming media includes the steps 810-830 (it should be known that, the sequence of all steps mentioned in this embodiment can be adjusted according to the actual needs and all or part of them can even be performed simultaneously, except expressly specified otherwise).

In the step 810, when one of plural wireless mobile devices (i.e., streaming requestor) transmits a streaming service request through a wireless network, the streaming service request is received; in the step 820, packets of the streaming data are generated and identification information are added to the packets of the streaming data; and in the step 830, the packets of the streaming data are transmitted to the wireless mobile device transmitting the streaming service request (i.e., streaming requestor) in the unicast manner, while the other wireless mobile devices (i.e., streaming audiences) eavesdrop the packets of the streaming data.

Furthermore, the step 820 can include: encoding the streaming data with a forward error-correction code and then providing the packets of the streaming data so that the wireless mobile devices decode and recover the forward error-correction code and then play media based on the streaming data.

In the method 800 of broadcasting wireless streaming media, when the identification information matches with the recognition information set by the eavesdropping wireless mobile devices, the eavesdropping wireless mobile devices receive the packets of the streaming data matching with the recognition information and play media based on the streaming data.

Although the invention has been disclosed with reference to the above embodiments, these embodiments are not intended to limit the invention. It will be apparent to those of skills in the art that various modifications and variations can be made without departing from the spirit and scope of the invention. Thus, the scope of the invention should be defined by the appended claims.

What is claimed is:

1. A wireless mobile device, comprising:
an eavesdropping module, for eavesdropping a packet of streaming data through a wireless network;
a packet-filtering module, for determining whether the packets of the streaming data have identification information, wherein when the packets of the streaming data have the identification information as determined, the packet-filtering module allows the streaming data to be passed; and
to a streaming player unit, for playing media based on the passed streaming data.

2. The wireless mobile device of claim 1, further comprising:
a forward error-correction code (FEC) removing module, for removing a forward error-correction code from the passed streaming data, wherein after the forward error-correction code is removed, the streaming player unit plays media based on the passed streaming data.

3. The wireless mobile device of claim 1, further comprising:
a preload module, for preloading the identification information as recognition information, wherein the packet-filtering module determines whether headers of the packets of the streaming data comprise the identification information, when the headers do not comprise the identification information, the packet-filtering module filters the packets of the streaming data and when the headers comprise the identification information, the packet-filtering module allows the streaming data to be passed.

4. The wireless mobile device of claim 1, further comprising:
a preload module, for preloading the identification information in the headers of a plurality of different packets of streaming data; and
a switch unit, for selecting one of the identification information as recognition information, wherein the eavesdropping module eavesdrops different packets of the streaming data and the packet-filtering module only allows packets of the streaming data having the recognition information in the different packets of the streaming data to be passed.

5. The wireless mobile device of claim 1, wherein the streaming data is video streaming data, audiovisual streaming data or audio streaming data.

6. A system of broadcasting wireless streaming media, comprising:
a wireless transmission device; and
at least one streaming server, comprising:
a receiving module, for receiving a streaming service request through the wireless transmission device when one of a plurality of wireless mobile devices transmits the streaming service request through a wireless network;
a processing module, for generating packets of streaming data and adding identification information to the packets of the streaming data; and
a transmission module, for transmitting the packets of the streaming data to the wireless mobile device transmitting the streaming service request through the wireless transmission device in an unicast manner, while the other wireless mobile devices eavesdrop the packets of the streaming data.

7. The system of broadcasting wireless streaming media of claim 6, wherein the wireless transmission device is a wireless base station and the wireless base station is connected to the streaming server through a wired network.

8. The system of broadcasting wireless streaming media of claim 6, wherein the wireless transmission device is installed in the streaming server.

9. The system of broadcasting wireless streaming media of claim 6, wherein the processing module encodes the streaming data with a forward error-correction code and then provides the packets of the streaming data, and the wireless mobile devices decode and recover the forward error-correction code and then plays media based on the streaming data.

10. The system of broadcasting wireless streaming media of claim 6, wherein the number of streaming servers is plural and, when each receiving the streaming service request, the streaming servers transmit different packets of the streaming data to the corresponding wireless mobile device transmitting the streaming service request in the unicast manner, while the other wireless mobile devices eavesdrop the different packets of the streaming data; and when the identification information of any one of the different packets of the streaming data matches with recognition information set by the eavesdropping wireless mobile devices, the eavesdropping wireless mobile devices receive the packets of the streaming data matching with the recognition information and play media based on the streaming data.

11. The system of broadcasting wireless streaming media of claim 6, wherein the wireless network is a Wi-Fi wireless network or a network of 802.11.

12. A method of broadcasting wireless streaming media, comprising:
receiving a streaming service request when one of a plurality of wireless mobile devices transmits the streaming service request through a wireless network;
generating packets of streaming data and adding identification information to the packets of the streaming data; and
transmitting the packets of the streaming data to a wireless mobile device transmitting the streaming service request in an unicast manner while the other wireless mobile devices eavesdrops the packets of the streaming data.

13. The method of broadcasting wireless streaming media of claim 12, wherein the step of generating packets of streaming data and adding identification information to the packets of the streaming data comprises: encoding the streaming data with a forward error-correction code and then providing the packets of the streaming data so that the wireless mobile devices decode and recover the forward error-correction code and then play media based on the streaming data.

14. The method of broadcasting wireless streaming media of claim 12, wherein when the identification information matches with recognition information set by the eavesdropping wireless mobile devices, the eavesdropping wireless mobile devices receive the packets of the streaming data matching with the recognition information and play media based on the streaming data.
